(19) United States
(12) Patent Application Publication
(10) Pub. No.: US 2013/0191193 A1
(43) Pub. Date: Jul. 25, 2013

(54) SHOPPING PLAN MANAGEMENT

(71) Applicants: Matthew A. Calman, Charlotte, NC (US); Erik Stephen Ross, Charlotte, NC (US); Susan Smith Thomas, Gastonia, NC (US); Jooyong Lee, Silver Spring, MD (US); Zhenshuo Fang, San Francisco, CA (US); James Mulholland, San Francisco, CA (US); Brendan Kiu, Sunnyvale, CA (US); Nastasha Tan, Torrance, CA (US)

(72) Inventors: Matthew A. Calman, Charlotte, NC (US); Erik Stephen Ross, Charlotte, NC (US); Susan Smith Thomas, Gastonia, NC (US); Jooyong Lee, Silver Spring, MD (US); Zhenshuo Fang, San Francisco, CA (US); James Mulholland, San Francisco, CA (US); Brendan Kiu, Sunnyvale, CA (US); Nastasha Tan, Torrance, CA (US)

(73) Assignee: BANK OF AMERICA CORPORATION, Charlotte, NC (US)

(21) Appl. No.: 13/355,886

(22) Filed: Jan. 23, 2012

(51) Int. Cl. G06Q 30/00; G01C 21/00

(52) U.S. Cl. 705/14.4; 705/27.1; 705/323; 705/1.1

(57) ABSTRACT

Embodiments of the invention include systems, methods, apparatuses, and computer-program products that provide shopping plan optimization. In one embodiment of the invention, information associated with a shopping plan is retrieved by the system; the shopping plan may include a grocery or other shopping list. The system compares the information associated with the shopping plan to a database. The database may include information associated with a plurality of merchants and businesses. The system optimizes the shopping plan based at least partially on the comparison of the information associated with the shopping plan to the database. In an embodiment, the system optimizes the shopping by determining an efficient travel route based on the products and/or items in the shopping plan.

### FIELD

In general, embodiments of the invention relate to systems, methods, and computer program products for optimizing a shopping plan.

### BACKGROUND

The following U.S. patent application is filed concurrently with the present application and is hereby incorporated by reference: U.S. patent application Ser. No. ______ to Calman et al. and entitled “Directional Wayfinding.”

There are continued and ongoing efforts by consumers to effectively manage their time and money expended on shopping and making purchases for various products and services. Currently, to help manage their time and money consumers create shopping plans and/or lists that may include a multitude of products that the consumer desires to purchase. Often times a consumer is not certain whether certain merchants or retailers have in stock the items on the list, how to find the merchants or products, the best price for the item, or possible alternatives for the item that could potentially save the consumer money. This type of merchant product information is usually not readily available to a consumer and in most cases when this merchant product information is available to the consumer it requires a significant amount of time searching the merchant stores, merchant ads, or merchant websites to determine the information. Visually-impaired or blind consumers may have difficulty navigating these various resources for price and product information because the form in which the merchant product information is presented is normally not readily usable by a visually-impaired or blind consumer. As such, there is a need for a method, computer program product and system that provides shopping plan management for visually-impaired, blind, or sighted consumer,

### SUMMARY OF SELECTED EMBODIMENTS OF THE PRESENT INVENTION

The following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely present some concepts of the invention in a simplified form as a prelude to the more detailed description provided below.

In general terms, embodiments of the present invention relate to systems, apparatuses, methods, and computer program products for optimizing a shopping plan. In an embodiment of the present invention, the method involves retrieving information associated with at least one shopping plan. In some embodiments, the method compares the information associated with the at least one shopping plan to merchant product information for at least one merchant in a database. In other embodiments, the method optimizes the shopping plan based at least partially on the comparison of the information associated with the at least one shopping plan to the merchant product information for at least one merchant in the database. For example, the method can optimize the shopping plan in order to determine the most efficient travel route the user should follow in order to arrive at each item or business-merchant associated with the shopping plan. The method may optimize the route by determining the location of the user, the location of each product and/or merchant in the shopping plan, and determining the order to travel to each merchant and/or item and the actual routes to each item and/or merchant in the shopping plan.

Embodiments of the present invention provide a system for optimizing a shopping plan. In an embodiment of the invention, the system includes a communication interface and a database. The system also includes a processing device in communication with the communication interface and database, wherein the processing device is configured to: (a) retrieve information associated with at least one shopping plan, (b) compare the information associated with the at least one shopping plan to the merchant product information for at least one merchant in the database, and (c) optimize the at least one shopping plan based at least partially on the comparison of the information associated with the at least one shopping plan to the merchant product information for at least one merchant in the database.

Embodiments of the present invention further provide a computer program product comprising a non-transitory computer readable medium, wherein the non-transitory computer readable medium comprises one or more computer-executable program code portions that, when executed by a computer, cause the computer to (a) retrieve information associated with at least one shopping plan, (b) compare the information associated with the at least one shopping plan to merchant product information for at least one merchant in a database, and (c) optimize the at least one shopping plan based at least partially on the comparison of the information associated with the at least one shopping plan to the merchant product information for at least one merchant in the database.

### BRIEF DESCRIPTION OF THE DRAWINGS

Having thus described some embodiments of the present invention in general terms, reference will now be made to the accompanying drawings, where:

FIG. 1 is a flow diagram illustrating a general process flow for optimizing a shopping plan, in accordance with an embodiment of the present invention;

FIG. 2 is a block diagram illustrating technical components of a system for providing shopping plan optimization, in accordance with an embodiment of the present invention;

FIG. 3 is a block diagram illustrating technical components of a mobile device configured to participate in optimizing a shopping plan, in accordance with an embodiment of the present invention.

FIG. 4 is a block diagram of a financial institution's banking system, in accordance with some embodiments of the invention; and

FIG. 5 is a mixed block and flow diagram of a system for providing shopping plan optimization using a mobile phone, in accordance with an embodiment of the present invention.

### DETAILED DESCRIPTION OF EMBODIMENTS OF THE PRESENT INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements.

Methods, systems, apparatuses, and computer program products are described herein for optimizing a shopping plan. During the course of a period of time (e.g., a day, week, month, etc.), a user may record a shopping plan including a list of one or more products and/or services that he intends to examine or purchase at a business-merchant. Now, the consumer can store the list of one or more products and/or services to any device associated with the user having a storage device. The user may also record the list of one or more products and/or services in any manner and using any type of input device available, including verbally recording the information, using brail or some form of haptic technology to enter the information, or simply by typing the list into a storage device. Once the user is ready to evaluate the list or begin his shopping, the system can retrieve the information associated with the at least one shopping plan from the storage device associated with the user. After retrieving the information associated with the at least one shopping plan, the method and system compare the information associated with the at least one shopping plan to a database comprising at least merchant product information, and the method and system optimizes the at least one shopping plan based at least partially on the comparison of the information associated with the shopping plan to the merchant product information for at least one merchant in the database. The method and system can optimize the shopping plan in several ways. In some embodiments, the method and system optimizes the shopping plan by determining the most cost effective and efficient routes to products and/or merchants associated with the at least one shopping plan. Alternatively, the method and system can optimize the shopping plan by augmenting the shopping plan with promotional offers, preferred merchants, and alternative products and/or services that may save the user money, time, or both.

As illustrated, aspects of the present disclosure include methods, systems, and computer program products for optimizing a shopping plan. It will be appreciated that, although embodiments of the present invention are generally described in the context of optimizing a shopping plan, other embodiments of the invention provide optimization for other types of lists or plans, such as a to-do list or itinerary.

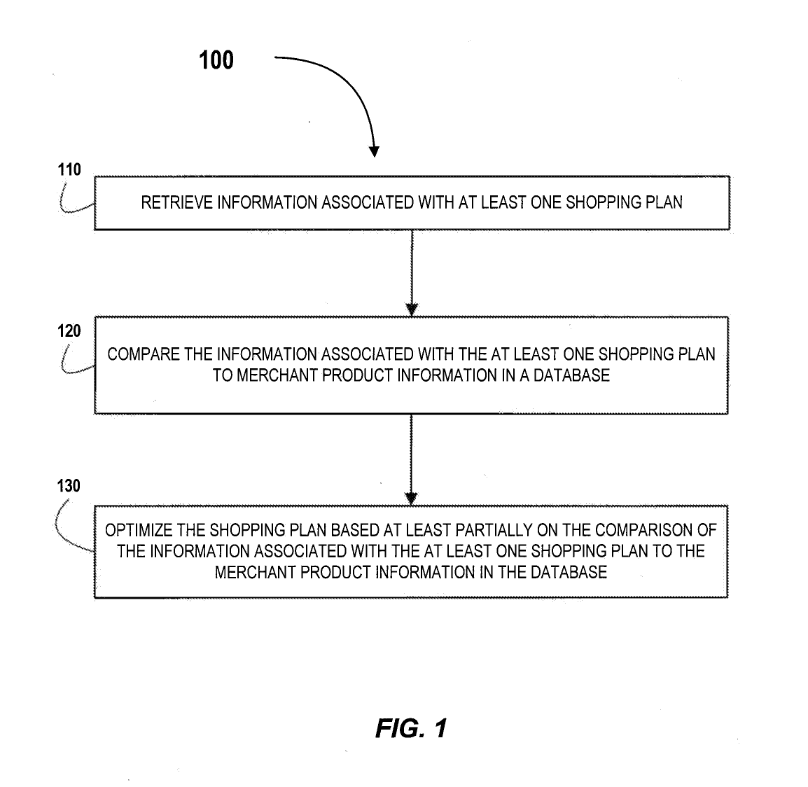

Referring now to FIG. 1, a general process flow 100 for optimizing a shopping plan is provided in accordance with an embodiment of the present invention. In some embodiments, the process flow 100 is performed by a system (i.e., one or more apparatuses) having hardware and/or software configured to perform one or more portions of the process flow 100. In such embodiments, as represented by block 110, the system is configured to retrieve information associated with at least one shopping plan. As represented by block 120, the system is also configured to compare the information associated with the at least one shopping plan to merchant product information for at least one merchant in a database. In addition, as represented by block 130, the system is further configured to optimize the shopping plan, based at least partially, on the comparison of the information associated with the shopping plan to merchant product information for at least one merchant in a database.

For simplicity, it will be understood that a portion of the process flow represented by blocks 110-130 is sometimes referred to herein as the “optimization application.” In addition, it will be understood that, in some embodiments, the term “determine” is meant to have one or more of its ordinary meanings (i.e., its ordinary dictionary definition(s)), but that in other embodiments, that term is meant to have one or more of the ordinary meanings of one or more of the following terms: decide, conclude, verify, ascertain, find, discover, learn, calculate, observe, read, and/or the like. Further, in some embodiments, the phrase “based at least partially on” is meant to have one or more of its ordinary meanings, but that in other embodiments, that phrase is meant to have one or more of the ordinary meanings of one or more of the following terms and/or phrases: as a result of, because of, after, if, when, in response to, and/or the like. Still further, in some embodiments, the term “via” is meant to have its one or more ordinary meanings, but in other embodiments, that term is meant to have one or more ordinary meanings of one or more of the following terms and/or phrases: through, per, with the assistance of, by way of, from, and/or the like.

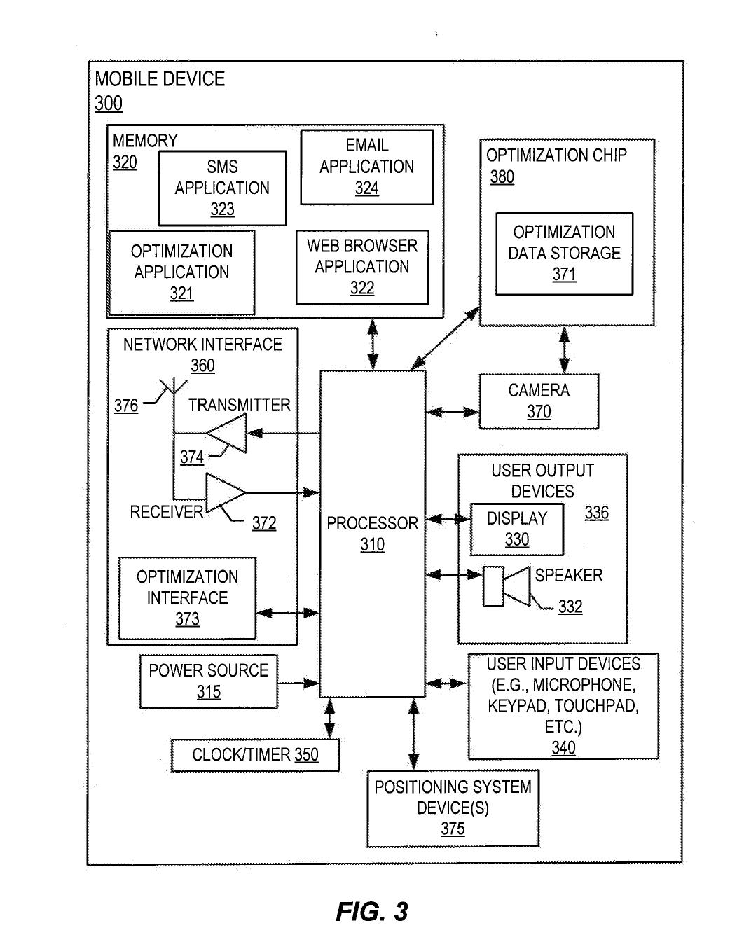

It will also be understood that the system having the process flow 100 can include one or more separate and/or different systems and/or one or more apparatuses. For example, in some embodiments, one apparatus (e.g., mobile computing device 300 described in connection with FIG. 3, etc.) is configured to perform the portion of the process flow 100 represented by blocks 110-120, and a system (e.g., the optimization machine) is configured to perform the portions represented by block 130. It will be understood that, in some embodiments, a mobile device or an optimization application is configured to perform one or more (or all) of the portions of the process flow 100.

Regarding block 110, the method and system having the process flow 100 can have one or more apparatuses configured to retrieve information associated with the at least one shopping plan using any method, means, and/or device. For example, in some embodiments, the system is configured to retrieve information associated with the at least one shopping plan from a storage device associated with the user, wherein the information associated with the at least one shopping plan comprises at least one recording of grocery items the user intends to purchase. As an example, in such embodiments, the storage device associated with the user may be memory on the user's mobile device, memory on the user home personal computer, memory in a cloud database system, or memory in a financial institution's system's memory. In some embodiments, the system is embodied as a mobile device associated with the user, wherein the mobile computing device is configured to retrieve, consider, and optimize the consumer shopping list. In a further example, using a mobile application, the system may retrieve a previously stored shopping list from the memory of the user's mobile device. Alternatively, the system may retrieve a plurality of shopping plans comprising a plurality of shopping lists from one or disparate remote storage devices using a mobile application on a user's mobile device. In other embodiments, the system retrieves the shopping list from a database associated with a financial institution. In yet another alternative embodiment of the present invention, the shopping plan is provided to storage device associated with the user by a third party. The third party may include a family member of the user, a business-merchant that the user frequents or is associated with a financial institution associated with the user, another an organization associated with the user, or an apparatus, method, machine, or software configured to determine shopping plan items or places and provide those shopping items and/or places to the storage device associated with the user.

The mobile device can include any number and/or type of mobile device(s). Examples of mobile devices include mobile phones (e.g., feature phones, smart phones, iPhones®, Droids®, etc.), mobile gaming devices (e.g., PlayStation Portable®, etc.), mobile computers (e.g., tablet computers, laptop computers, etc.), personal digital assistants (PDAs), and/or the like. In some embodiments, the mobile device is configured to send and/or receive communications (e.g., phone calls, text messages, actionable alerts, emails, social media-specific messages, etc.), present information via a user interface, play video games, and/or the like. In some embodiments, the mobile device is portable (e.g., not stationary) and/or can be carried and/or worn by and/or on a person.

In some embodiments, the mobile device includes one or more NFC interfaces that are configured to communicate with one or more NFC interfaces. For example, in some embodiments, where the mobile device is embodied as a mobile phone, the mobile phone has an NFC interface that can communicate account information and/or transaction information (e.g., account names, routing numbers, account numbers, usernames, passwords, PINs, transaction amounts, etc.) to and/or from the NFC interface of another device. In some of these embodiments, the mobile phone is configured to operate as a mobile wallet, meaning that the mobile phone can be used to make payments and/or otherwise engage in transactions at a transaction machine.

Further regarding block 110, the phrase “information associated with at least one shopping plan,” as used herein, means any type of data or information that identifies, defines, describes, and/or is otherwise associated with a proposal or course of action a consumer intends to pursue regarding the selection, examination, or purchase of products and/or services. Exemplary information associated with a shopping plan includes, but is not limited to, a shopping list, a grocery list, a wish list, a to-do list, an itinerary, etc. For example, the shopping plan may comprise a shopping list that may include one or more products that can be purchased from a business-merchant operating as a grocer. Alternatively, the shopping list may include one or more goods such as an automobile, clothing or one or more services such as dry cleaning and car maintenance. In other embodiments, the information associated with the at least one shopping plan may include a list of places and websites associated with one or more business-merchants that the consumer intends to visit. Alternatively, the information associated with a shopping plan may include a list of places and websites associated with one or more products associated with the shopping plan that the consumer intends to purchase. As one skilled in the art will appreciate, the phrase “information associated with a shopping plan” can be any type of data regarding a consumer's intends to examine and/or purchase one or more products and/or services from one or more business-merchants.

Still regarding block 110, the information associated with a shopping plan can also include any information that defines and/or identifies the type of shopping plan for a consumer. As understood herein, the shopping plan type may be defined, at least in part, by the one or more products and/or services included in the plan or the one or more proposed courses of conduct that a consumer intends to pursue using the shopping plan.

The term “consumer,” as described in many of the embodiments herein, refers to any person, association, machine, apparatus, and/or any other thing capable of buying, using, consuming, and/or acquiring one or more products from a business-merchant. In some embodiments, a consumer may be a business-merchant and/or vice versa. In other embodiments, a consumer may be a customer of a bank or some other financial institution.

The term “business-merchant,” as used herein, refers to any person, association, machine, apparatus, and/or any other thing capable of selling, offering for sale, distributing, trading, and/or otherwise dealing in one or more products and/or services. In some embodiments, the business-merchant(s) actually produce and/or provide the products and/or services being sold, while in other embodiments, the business-merchant(s) distribute the products and/or services but do not produce and/or provide the products and/or services. In one embodiment described herein, the business-merchant is a grocer that offers one or more grocery-related products to a consumer.

Regarding block 120, the method and system configured to perform process flow 100 compares the information associated with the at least one shopping plan to merchant product information for at least one merchant in a database. In some embodiments, the system having process flow 100 compares the information associated with the at least one shopping plan to merchant information provided to the database. For example, the information and/or product information provided by merchants to the database may include, but is not limited to, a complete list of products and/or services with associated prices, merchant store locations, merchant store hours, merchant store layout and planograms, merchant deals, specials and promotions, etc. The database may also include bus route and schedule information, available and alternative modes of transportation with corresponding route and schedule information, etc. In other embodiments, the system compares the information associated with the at least one shopping plan to the database, wherein the database comprises information provided by a financial institution. For example, the information provided by the financial institution may include product and/or service information associated with the financial institution, promotions and/or deals, etc. In still other embodiments, the system and method may be configured to match the information associated with the at least one shopping plan to information in a database. In some embodiments, the system and method may be configured to use the information associated with the shopping plan to retrieve data from a database.

Further regarding block 120, in some embodiments, the database is maintained by a financial institution, such as a bank. In other embodiments, the database comprises one or more rules. The one or more rules may relate at least partially to determining when to augment a shopping plan with additional and/or alternative products and/or services and/or additional or alternative business-merchants, deals, specials, and/or promotional offers. For example, the information associated with a user's shopping plan may include a shopping list including eggs and bread and the database may have stored therein a rule that relates at least partially to recommending purchasing milk when a consumer intends to purchase eggs and bread. In this instance, the system compares the shopping list to the one or more rules and determines that the user's shopping list should also include milk.

Turning to block 130, an optimizing application is configured to optimize the at least one shopping plan based at least partially on the comparison of the information associated with the at least one shopping plan to the merchant product information for at least one merchant in the database. In some embodiments, the optimization application optimizes the shopping plan by determining one or more merchant locations and/or websites associated with items in the shopping plan. In other embodiments, the optimizing application optimizes the shopping plan by determining the prices for each product and/or services at each business-merchant offering the product and/or service. In further embodiments, the optimizing application optimizes the shopping plan by determining travel routes that encourages healthy behavior. In yet other embodiments, the optimizing application determines the most efficient path to each of the places and/or items on the shopping plan based on the user's mobility patterns. In some embodiments, the optimization application optimizes a previously optimized shopping plan based on a user's selection of one or more items generated in an optimized shopping plan. This is effectively a re-optimization of an optimized shopping plan based on the user selection of one or more items from the optimized shopping plan. In yet other embodiments, the optimization application optimizes the shopping plan by determining a mood of the user associated with the shopping plan. In other embodiments, the optimizing application optimizes the shopping plan by determining an efficient path through a merchant store to each of the products and/or services associated with the user's shopping plan. In yet another embodiment of the invention, the optimization application optimizes the shopping plan by determining the user route based on the perishability and/or size of the one or more products associated with the shopping plan. In other embodiments, the optimization application optimizes the shopping plan by determining one or more products and/or services to augment to the user's shopping plan. In yet other embodiments, the optimization application optimizes the shopping plan by determining alternative products and/or services to include in the shopping plan. In still other embodiments, the optimization application optimizes the shopping plan by determining one or more merchants having all of the one or more products and/or services associated with the shopping plan. In another embodiment, the optimization application optimizes the shopping plan by determining ads and/or promotions to include with the shopping plan. In yet another embodiment, the optimizing application optimizes the shopping plan by determining the most efficient travel route to the one or more business-merchants associated with the shopping plan. In some embodiments, the optimization application optimizes the shopping plan by determining the business-merchants having the one or more products and/or services associated with the shopping plan and submitting the products and/or services to the business-merchant for purchase. In other embodiments, the optimization application optimizes the shopping plan by allowing a user to enter a meal and/or dish and determining all of the required and/or optional ingredients or components that the user may need to purchase to create the meal. In further embodiments, the optimization application optimizes the shopping plan by determining one or more meal or dish recommendations based at least partially on the user's shopping plan and/or preferences.

It will be understood that, in some embodiments, the term “optimize” is meant to have one or more of its ordinary meanings (i.e., its ordinary dictionary definition(s)), but that in other embodiments, that term is meant to have one or more of the ordinary meanings of one or more of the following terms: to make as effective, to perfect, to write or rewrite to maximize efficiency, to make functional, and/or the like. Further, in some embodiments, the phrase “based at least partially on” is meant to have one or more of the ordinary meanings of one or more of the following terms and/or phrases: as a result of, because of, after, if, when, in response to, and/or the like.

In some embodiments, the optimization application optimizes the at least one shopping plan by identifying one or more merchant locations and/or websites having the products and/or services available or inventory associated with the information associated with the at least one shopping plan. In such embodiments, the optimization application may determine all of the business-merchants having one or more of the items and/or services associated with the shopping plan based at least partially on the comparison of the information associated with the at least one shopping plan to merchant product information for at least one merchant in a database, the user's location, and other user preferences. In such embodiments, the user can input various types of preferences and/or limitations for optimization including distance, location, store type, ease of access, bus routes, maximum and minimum prices, etc. For example, a user's shopping plan may have two items including cereal and milk, but as a preset limitation for optimizing the user's shopping plan, the user is only willing to travel as far as six miles. Based at least partially on the user's location, shopping list, and preset distance limitation, the optimization application may determine that the items are readily available at five stores within a six mile radius of the user's location. Additionally, in another embodiment the optimization application and/or apparatus providing optimization of the at least one shopping plan is in communication with a server associated with at least one merchant and/or a plurality of merchants, wherein the server includes product inventory information and/or product and/or service availability information. In some embodiments, the method determines the location of the user and/or merchant by triangulation of wireless signals, such as GPS or Wi-Fi. Alternatively, the user may input the user's location. Location of the user could also be determined based on accelerometers, gyroscopes, earth magnetic field sensors, air-pressure sensors (altitude), etc.

In further embodiments, the optimization application determines the most efficient route to the one or more places and/or items associated with the shopping plan based on the user's mobility patterns. The determination of a user's mobility patterns by analyzing the locations and/or business visited by the user associated with the user's mobile computing device within a prescribed time frame (e.g., hourly, daily, weekly, monthly, etc.). Additionally, mobility patterns may be assessed based on financial behavior data and social media data. The financial behavior data may be determined based on credit, debit, and other demand deposit account purchases/transactions. As an example, the user associated with the shopping plan may on a weekly basis visit her dry cleaners every Monday and Thursday morning of every week and the user may also visit her financial institution for deposit every Monday and Thursday afternoon of every week and based at least partially on this mobility pattern information, the optimization application optimizes the user's shopping plan to determine the most efficient route to the items and/or places associated with the shopping plan while accommodating the mobility routines of the user.

In some embodiments, the optimization application determines a route that would lead the user to the one or more products and/or services associated with the at least one shopping plan in a facility. In some embodiments, the system performing process flow 100 determines the location of the user by triangulation of wireless signals in the business, such as GPS or Wi-Fi. In another embodiment, the location of the user is determined based on distance from pre-set markers. In some embodiments, the mobile device determines the user's location. As the user enters the business, the GPS signal may be lost but an accelerometer associated with the mobile device may determine that user's direction and speed so that the user's current location can be calculated based on the user's initial location. Additionally or alternatively, the business may determine the user's location. The method and system also determines a location of the product in the facility. In one embodiment, the system receives the location of the product from the facility itself. For example, the facility may provide a planogram of the products within the facility. The planogram may be provided for the initial set-up of the facility or may be updated with the most recent set-up. Facilities may change the location of products frequently, however, so the planogram may not be up-to-date. In some embodiments, the planogram is augmented or replaced by crowdsourcing data. Crowdsourcing data are data provided by individuals through social media. In some instances, individuals shopping within businesses can tag or update the location of products. In a still further embodiment, products are tagged and provide the location the method. For example, the business and/or the manufacturing may tag products with a label, such as an RFID label, that can be located by the method. As discussed, the method may also receive a facility map along with the planogram, where the facility map provides the layout of paths and objects in the facility.

In still other embodiments, the optimization application determines a route that would lead the user to the one or more business-merchants and/or one or more organization locations associated with the at least one shopping plan. There are some known algorithms for route optimization such as the traveling salesman algorithm that can be combined and used in addition to the optimization application that may enhance the efficiency of the route determined for the user. In such embodiments, the location of the user is determined based on the initial location of the user. For example, a GPS may determine that the user is at the user's home location. Similarly, the one or more locations of the one or more business-merchants and/or the one or more organization locations associated with the at least one shopping plan may be determined using GPS. In such embodiments, the optimization application optimizes the shopping plan based at least partially on the comparison of the at least one shopping plan to a database, the user's location, and other user preferences.

In yet other embodiments, the optimization application determines one or more moods of the user associated with the shopping plan. In some embodiments, the optimization application may determine the mood of the user based on the user's deviations from the shopping plan or based on the purchases and/or transactions and/or locations of the user during a timeframe. In this way, once the optimization application determines the mood of the user associated with the shopping plan, the optimization application may make recommendations to the user to enhance, further, hinder, or otherwise alter the mood of the user. The recommendations may include suggestions for products and/or services that compliment or supplement the user's transactions or travel variations. The recommendations may also include healthy suggestions in the cases when the optimization application determines a mood for the user that is consistent with unhealthy behaviors (e.g., purchasing foods and candies that may lead to health issues). For example, a user's optimized or un-optimized shopping plan may include milk, bread, and eggs but during the execution of the shopping plan the user selects and purchases popcorn and candy. Based on the user's variation and the purchase of popcorn and candy, the optimization application may determine that the user is in the mood for a movie and the optimization application may further suggest a movie, a movie rental location, and/or other complimentary items that would enhance the user's movie experience.

In other embodiments, the optimization application determines one or more products and/or services to augment to a user's shopping plan. In some embodiments, the optimization application determines the one or more products to augment to the user's shopping plan based at least on one or more of a variety of data including, the information associated with the shopping plan, previous shopping plan data and/or shopping plan history, past transaction data and/or history, proximity to the product and/or to a merchant offering the product, biographical data, social network data, publicly available information, other user preferences, etc. For example, a user's shopping plan may include peanut butter and wheat bread. In some embodiments, the system may determine based on the comparison of the information associated with shopping plan to the database and based on the user's previous shopping plan, that the plan should also include jelly, and not only peanut butter and bread. In this way, the optimization applications provides a comprehensive shopping plan including the items the user would normally purchase or would otherwise be inclined to purchase. In still alternative embodiments, the optimization application determines alternative one or more products and/or services to be purchased in lieu of an item the user provided to the shopping plan. Based at least partially on the comparison of the shopping plan to the database, the optimization application may determine that the alternative one or more products and/or services are cheaper, superior, or simply a new item that the user may be inclined to try.

In some embodiments, the optimization application optimizes the shopping plan by determining the one or more business-merchants having the one or more products and/or services associated with the shopping plan and submitting the one or more products and/or service to the business-merchant having the one or more products and/or services based on user preferences. For example, where the user's shopping plan comprises a grocery list of products to purchase, the optimization application may determine the local grocers having the grocery list of items and the application may submit the products to one or more local grocers for purchase. In this way, the grocery list of items may be ready for pick up without the user having to expend her time searching for the items.

In other embodiments, the optimization application determines one or more ads (e.g., merchant flyer information, weekly ads, etc.) and/or promotions (e.g., merchant specials, deals, etc.) or an offer to the user. In some embodiments, the optimization application determines the one or more ads and/or promotions or offer based at least partially on one or more of a variety of data including, the comparison of information associated with the shopping plan to a database, previous shopping plan data and/or history, past transaction data and/or history, proximity to a product and/or to a merchant offering a product, biographical data, social network data, publicly available information, other user preferences, etc. In this way, the optimization application optimizes the shopping plan for maximum dollar savings on the items the user intends to purchase. In one embodiment, the system optimizes the shopping plan by providing an offer associated with the business or organization that the user is visiting. For example, if the user is shopping in grocery store, and the user's financial transaction history indicates a history of shopping at farmers markets, a coupon for a type of vegetable may be provided to the user. In another embodiment, the offer is an advertisement. For example, the offer may be an advertisement for a product or service in the business. In other embodiments, the offer may include a coupon, a solicitation, or a request for volunteer service, etc. The offer may be customized for the user with data from the user's financial accounts or user profile. The offer may be in visual (e.g., a written advertisement or a picture, etc.) or audible (e.g., a recording, a jingle, etc.) format.

In other embodiments, the optimization application optimizes the shopping plan by re-optimizing a previously optimized shopping plan based on a user's selection of one or more items and/or places on the previously optimized shopping plan. For example, the user may have optimized her shopping plan to determine one or more alternative products and/or services options to purchase in lieu of one or more items entered by the user onto the shopping plan. The user may then select one or several of the items from the one or more alternative products and/or services generated by the optimization application. Once the user makes her one or more selections from the optimized list, the user may again initiate another optimization or re-optimization of the shopping plan including the new selection. The user may re-optimize the variant of the initial shopping plan to determine more alternative products and/or services to purchase or to determine a new route to the items and/or places associated with the shopping plan or to determine other forms of optimization disclosed in the present application or known in the art.

In some embodiments, the optimization application optimizes the shopping plan to determine one or more routes to the items and/or places associated with the shopping plan that encourages healthy behaviors (e.g., walking, running, biking, etc.). For example, a user may set as a preference that she desires to bike a portion of the route associated with the shopping plan or she may merely initiate the optimization application to determine portions of the route associated with the plan that can be traveled using a bike. As such, the user may then select the portions of the route associated with the shopping plan that she desires to travel using her bike.

In yet another embodiment, the optimization application optimizes the shopping plan by determining the route at a business-merchant to one or more products associated with the shopping plan. In an embodiment, the route is determined so that the user conveniently receives the items in a specific order. For example, the user may be directed to dry goods first, refrigerated goods second and frozen goods third. In another example, the user is directed to products based on the size or difficult in transporting the products. The user may be directed to small, easily transportable products before being direct to large, bulky, or difficult to transport products. It should be understood that characteristics of the products can be evaluated while determining the route.

The transaction data referred to herein can be any data that identifies, defines, describes, and/or is otherwise associated with a transaction. Exemplary transaction information includes, but is not limited to, the party(ies) involved in the transaction the date and/or time of the transaction, the location of the transaction, the account(s) involved in the transaction, the transaction amount(s) associated with the transaction, the good(s) and/or service(s) involved in the transaction (e.g., product names, stock keeping unit (SKU) information, universal product code (UPC) information, etc.), the channel(s) (e.g., ATM, teller terminal, point of sale device, etc.) through which the transaction is conducted, a description of the transaction (which, itself, can include any transaction information, e.g., the description may describe the transactions status, the transaction amount, the merchant involved in the transaction, the good(s) and/or service(s) involved in the transaction, etc.), and/or the like.

The transaction data can also include any information that defines and/or identifies the type of the transaction. As understood herein, the transaction type of a transaction may be defined, at least in part, by the one or more products and/or services involved in the transaction, the one or more types of accounts involved in the transaction (e.g., credit card transaction, savings account transaction, etc.), the one or more parties involved in the transaction (e.g., account holder, bank, teller, merchant, counterparty, etc.), when the transaction was initiated (e.g., time of day, day of week, etc.), and/or the like. In some embodiments, the transaction type is defined, at least in part, by the one or more channels through which the transaction is conducted, such as, for example, a POS device (e.g., merchant terminal, etc.), ATM, teller terminal, electronic banking account (e.g., online banking account, mobile banking account, SMS banking account, etc.), personal computer, kiosk, call center, and/or the like. Additionally or alternatively, in some embodiments, the transaction type is defined, at least in part, by the one or more instruments and/or methods used to conduct the transaction, such as, for example, paper checks, electronic checks, debit cards, credit cards, ATM cards, checkcards, wire transfers, online bill pay, automated clearing house (ACH), contactless payments, near field communication (NFC) interface payments, cash payments, and/or the like.

As will be discussed, the method of process flow 100 may have a variety of supplemental steps and accomplish the steps in a variety of ways. Further, the steps do not need to be performed in the order discussed herein. The examples disclosed herein are not intended to be limiting to the various ways in which a mobile device can optimize a shopping plan.

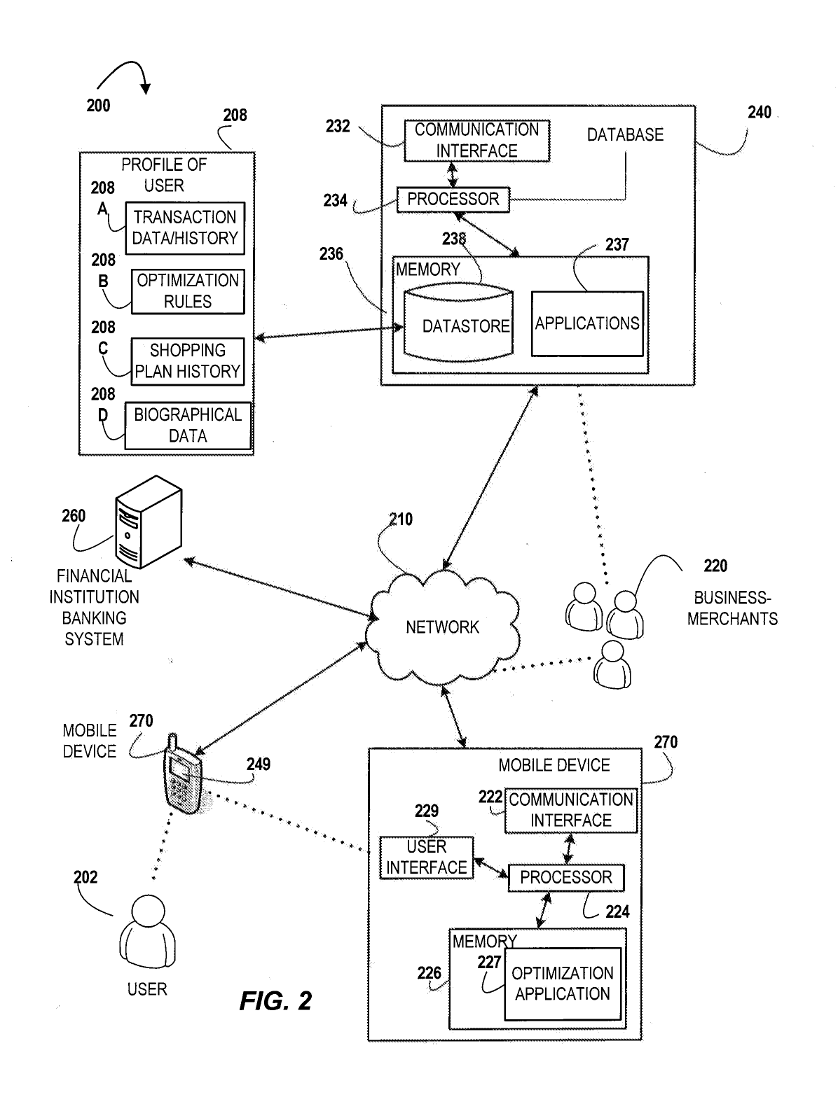

Referring to FIG. 2, a block diagram illustrating an environment 200 for providing shopping plan optimization, in accordance with an embodiment of the present invention. As illustrated, the system 200 includes a network 210, a plurality of business-merchants 220, a database 240, a financial institution system 260, and a mobile device 270. FIG. 2 also shows a user 202 and a profile 208 of user 202. The database 240 having the merchant production information and a portion of the profile 208 of the user is maintained by the same financial institution that is maintaining the financial institution system 260 at which the user 202 is a customer. As shown, the profile 208 includes transaction data 208A associated with the profile (and/or user) and/or information about the user. The shopping plan 204 is stored in the memory 226 of the mobile device 270.

In accordance with some embodiments, the database 240 and the financial institution system 260 are each maintained by the same financial institution. For example, in some embodiments, the user 202 is a customer of the financial institution and the data provided to the database 240 by a plurality of merchants 220 is maintained and managed by the financial institution. However, in other embodiments, the database 240 and the financial institution system 260 are maintained by separate entities. In accordance with some embodiments, the mobile device 270 is associated with the user 202 and/or is carried, owned, possessed, and/or owned by the user 202.

As shown in FIG. 2, the mobile device 270, the database 240, financial institution system 260, and the plurality of business-merchants 220 are each operatively and selectively connected to the network 210. The network 210 may include telephone networks (e.g., cellular networks, CDMA networks, any wireline and/or wireless network over which communications to telephones and/or mobile phones are sent, etc.), local area networks (LANs), wide area networks (WANs), global area networks (GANs) (e.g., the Internet, etc.), and/or one or more other telecommunications networks. For example, in some embodiments, the network 210 includes a telephone network (e.g., for communicating with the mobile device 270, etc.). It will be understood that the network 210 may be secured and/or unsecured and may also include wireless and/or wireline technology.

As illustrated in FIG. 2, in this example embodiment, the mobile device 270 includes a communication interface 222, a processor 224, a memory 226 having a optimization application 227 stored therein, and a user interface 229. The processor 224 is operatively and selectively connected to the communication interface 222, the user interface 229, and the memory 226.

Each communication interface described herein generally includes hardware, and, in some instances, software, that enables a portion of the system 200, such as the mobile device 270, to send, receive, and/or otherwise communicate information to and/or from the communication interface of one or more other portions of the system 200. For example, the communication interface 222 of the mobile device 270 may include a modem, network interface controller (NIC), NFC interface, network adapter, network interface card, and/or some other electronic communication device that operatively connects the mobile device 270 to another portion of the system 200, such as, for example, the financial institution system 260.

Each processor described herein, including the processor 224, generally includes circuitry for implementing the audio, visual, and/or logic functions of that portion of the system 200. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the optimization application 227 of the memory 226 of the mobile device 270.

Each memory device described herein, including the memory 226 for storing the optimization application 227 and other information, may include any computer-readable medium. For example, the memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of portions of information used by the apparatus in which it resides to implement the functions of that apparatus.

As shown in FIG. 2, the memory 226 includes the optimization application 227. It will be understood that the optimization application 227 can be operable (e.g., usable, executable, etc.) to initiate, perform, complete, and/or facilitate one or more portions of any embodiment described and/or contemplated herein, such as, for example, one or more portions of the process flows 100 described herein.

The optimization application 227 can be operable (e.g., usable, executable, etc.) to initiate, perform, complete, and/or facilitate any one or more portions of the process flow 100 described herein. For example, in some embodiments, the optimization application 227 is operable to retrieve information associated with a shopping plan. As another example, in some embodiments, the optimization application 227 is operable to compare the information associated with the at least one shopping plan to a database. In further embodiments, the optimization application 227 is operable to optimize the at least one shopping plan based, at least partially, on the comparison of the information associated with the at least one shopping plan to the database.

The optimization application 227 can also be operable to receive from the user 202 preferences and/or limitations. In some embodiments, the optimization application 227 is operable to receive from the user 202 preference information as verbal input from the user 202. In other embodiments, the optimization application 227 retrieves user 202 preferences from the memory 226 of the user's mobile device 240. In other embodiments, the optimization application 227 is operable to receive preference information from the user 202 from the user interface of the mobile device 270.

In other embodiments, the optimization application 227 is configured to execute on a personal computer associated with the user, and, in some embodiments, the optimization application 227 is embodied as a web browser (i.e., for navigating the Internet, etc.) that is operable to initiate, perform, complete, and/or otherwise facilitate one or more portions of any embodiment described and/or contemplated herein.

In some embodiments, the optimization application 227 is operable to enable the user 202 and/or mobile device 270 to communicate with one or more other portions of the system 200, and/or vice versa. In some embodiments, the optimization application 227 is additionally or alternatively operable to initiate, perform, complete, and/or otherwise facilitate one or more financial and/or non-financial transactions. In some embodiments, the optimization application 227 includes one or more computer-executable program code portions for causing and/or instructing the processor 224 to perform one or more of the functions of the optimization application 227 and/or mobile device 270 described and/or contemplated herein. In some embodiments, the optimization application 227 includes and/or uses one or more network and/or system communication protocols.

It will be understood that the database 240 can be configured to store any type and/or amount of information. In addition, the database 240 may include information associated with one or more business-merchants (e.g., a retailer, wholesaler, clothier, grocer, etc.). The information associated with one or more business-merchants may include, for example, a detailed products and/or services list including the prices, bar code, UPC, SKU, and other relevant information regarding the products and/or services offered by the one or more business-merchants. The information associated with the one or more business-merchants may also include business-merchant store layout information, business-merchant planograms and product location, ads and/or promotions, deals, and sales for merchant products and/or services. In some embodiments, the database additionally or alternatively stores information associated with a financial institution (e.g., a bank) that is associated with the financial institution system 260.

In some alternative embodiments, a datastore, one or more databases, one or more storage devices, and/or any of the storage devices typically associated with a computer may be used in lieu of the database 240. It will also be understood that the database 240 may store information in any known way, such as, for example, by using one or more computer codes and/or languages, alphanumeric character strings, data sets, figures, tables, charts, links, documents, and/or the like. Further, in some embodiments, the database 240 includes information associated with one or more applications. In some embodiments, the database 240 provides a real-time or near real-time representation of the information stored therein, so that, for example, when a processor accesses the database 240, the information stored therein is current or nearly current.

FIG. 3 illustrates an embodiment of a mobile device 300 that may be configured to execute the shopping plan optimization functionality. A “mobile device” 300 may be any mobile communication device, such as a cellular telecommunications device (i.e., a cell phone or mobile phone), personal digital assistant (PDA), smartphone, a mobile Internet accessing device, or other mobile device including, but not limited to portable digital assistants (PDAs), pagers, mobile televisions, gaming devices, laptop computers, tablet computers, cameras, video recorders, audio/video players, radios, GPS devices, and any combination of the aforementioned, or the like. In some embodiments, the mobile device 300 includes a wired or wireless connection to a communication device, such as an earpiece, stereo headset, or other communication device, wherein the communication device is configured to relay shopping plan optimization information to the user. In a further embodiment, the shopping plan optimization technology is embedded in a bracelet operably linked to a communication device, such as a stereo headphone, for communicating with the user.

The mobile device 300 may generally include a processor 310 communicably coupled to such components as a memory 320, user output devices 336, user input devices 340, a network interface 360, a power source 315, a clock or other timer 350, a camera 370, at least one positioning system device 375, one or more optimization chips 380, etc. The processor 310, and other processors described herein, may generally include circuitry for implementing communication and/or logic functions of the mobile device 300. For example, the processor 310 may include a digital signal processor device, a microprocessor device, and various analog to digital converters, digital to analog converters, and/or other support circuits. Control and signal processing functions of the mobile device 300 may be allocated between these devices according to their respective capabilities. The processor 310 thus may also include the functionality to encode and interleave messages and data prior to modulation and transmission. The processor 310 may additionally include an internal data modem. Further, the processor 310 may include functionality to operate one or more software programs or applications, which may be stored in the memory 320. For example, the processor 310 may be capable of operating a connectivity program, such as a web browser application 322. The web browser application 322 may then allow the mobile device 300 to transmit and receive web content, such as, for example, location-based content and/or other web page content, according to a Wireless Application Protocol (WAP), Hypertext Transfer Protocol (HTTP), and/or the like.

In some embodiments, the positioning system device 375 is configured to determine the location of the mobile device. For example, at least one of the position system devices 375 may interact with the transceiver to send and/or receive information with wireless transmitters, such as GPS or Wi-Fi. In further embodiments, the positioning system device 375 is configured to determine movement and/or orientation of the mobile device. Accelerometers, magnetometers, and other devices can be included in the mobile device to provide information to the device on the location and velocity (speed and direction) of the device. Other types of positioning system devices 375 may be included in the device without limitation. For example, altimeters can be included in the device to determine the elevation of the device. Similarly, electronic or standard compasses may be included.

The processor 310 may also be capable of operating applications, such as an optimization application 321. The optimization application 321 may be downloaded from a server and stored in the memory 320 of the mobile device 300. Alternatively, the optimization application 321 may be pre-installed and stored in a memory in the optimization chip 380 or activated directly from a website operably linked to the mobile device 300 through the network interface 360. In embodiments where the optimization application 321 is pre-installed or run from a website, the user may not download the optimization application 321 from a server.

The optimization chip 380 may include the necessary circuitry to provide the optimization functionality to the mobile device 300. Generally, the optimization chip 380 will include optimization data storage 371, i.e., a database, which may include data associated with products in a facility, such as location, facility maps, and/or planogram data. The optimization chip 380 and/or optimization data storage 371 may be an integrated circuit, a microprocessor, a system-on-a-chip, a microcontroller, or the like. As discussed above, in one embodiment, the optimization chip 380 provides the optimization functionality to the mobile device 300.

It will be understood that while FIG. 3 illustrates the optimization chip 380 as a separate and distinct element within the mobile device 300, it will be apparent to those skilled in the art that the optimization chip 380 functionality may be incorporated within other elements in the mobile device 300. For instance, the functionality of the optimization chip 380 may be incorporated within the mobile device memory 320 and/or the processor 310. In a particular embodiment, the functionality of the optimization chip 380 is incorporated in an element within the mobile device 300 that provides optimization capabilities to the mobile device 300. Moreover, the functionality may be part of the firmware of the mobile device 300. In some embodiments, the functionality is part of an application downloaded and installed on the mobile device 300. Still further, the optimization chip 380 functionality may be included in a removable storage device such as an SD card or the like.

The processor 310 may be configured to use the network interface 360 to communicate with one or more other devices on a network. In this regard, the network interface 360 may include an antenna 376 operatively coupled to a transmitter 374 and a receiver 372 (together a “transceiver”). The processor 310 may be configured to provide signals to and receive signals from the transmitter 374 and receiver 372, respectively. The signals may include signaling information in accordance with the air interface standard of the applicable cellular system of the wireless telephone network that may be part of the network. In this regard, the mobile device 300 may be configured to operate with one or more air interface standards, communication protocols, modulation types, and access types. By way of illustration, the mobile device 300 may be configured to operate in accordance with any of a number of first, second, third, and/or fourth-generation communication protocols and/or the like. For example, the mobile device 300 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 300 may also be configured to operate in accordance with non-cellular communication mechanisms, such as via a wireless local area network (WLAN) or other communication/data networks.

The network interface 360 may also include an optimization interface 373 in order to allow a user to execute some or all of the above-described processes with respect to the optimization application 321 and/or the optimization chip 380. The optimization interface 373 may have access to the hardware, e.g., the transceiver, and software previously described with respect to the network interface 360. Furthermore, the optimization interface 373 may have the ability to connect to and communicate with an external optimization data storage on a separate system within the network. In some embodiments, the optimization interface 373 communicates with the financial institution banking system 400. In other embodiments, the optimization interface 373 communicates with the plurality of business-merchants 280, such as by wireless communication.

As described above, the mobile device 300 may have a user interface that includes user output devices 336 and/or user input devices 340. The user output devices 336 may include a display 330 (e.g., a liquid crystal display (LCD) or the like) and a speaker 332 or other audio device, which are operatively coupled to the processor 310. In an exemplary embodiment, the user output devices 336 include stereo headphones, such as over-ear headphones or in-ear headphones that provide aural information to the user. The user input devices 340, which may allow the mobile device 300 to receive data from a user 202, may include any of a number of devices allowing the mobile device 300 to receive data from a user 202, such as a keypad, keyboard, touch-screen, touchpad, microphone, mouse, joystick, stylus, other pointer device, button, soft key, and/or other input device(s).

The mobile device 300 may further include a power source 315. Generally, the power source 315 is a device that supplies electrical energy to an electrical load. In one embodiment, power source 315 may convert a form of energy such as solar energy, chemical energy, mechanical energy, etc. to electrical energy. Generally, the power source 315 in the mobile device 300 may be a battery, such as a lithium battery, a nickel-metal hydride battery, or the like, that is used for powering various circuits, e.g., the transceiver circuit, and other devices that are used to operate the mobile device 300. Alternatively, the power source 315 may be a power adapter that can connect a power supply from a power outlet to the mobile device 300. In such embodiments, a power adapter may be classified as a power source “in” the mobile device.

The mobile device 300 may also include a memory 320 operatively coupled to the processor 310. As used herein, memory may include any computer readable medium configured to store data, code, or other information. The memory 320 may include volatile memory, such as volatile Random Access Memory (RAM) including a cache area for the temporary storage of data. The memory 320 may also include non-volatile memory, which can be embedded and/or may be removable. The non-volatile memory may additionally or alternatively include an electrically erasable programmable read-only memory (EEPROM), flash memory or the like.

The memory 320 may store any of a number of applications or programs which comprise computer-executable instructions/code executed by the processor 310 to implement the functions of the mobile device 300 described herein. For example, the memory 320 may include such applications as an optimization application 321, a web browser application 322, an SMS application 323, an email application 324, etc.

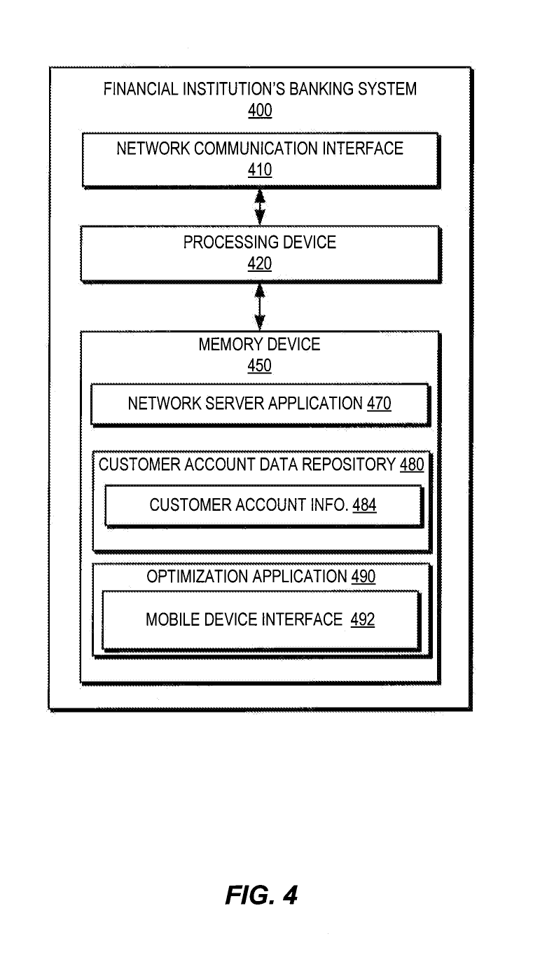

FIG. 4 provides a block diagram illustrating the banking system 400 in greater detail, in accordance with embodiments of the invention. As illustrated in FIG. 4, in one embodiment of the invention, the banking system 400 includes a processing device 420 operatively coupled to a network communication interface 410 and a memory device 450. In certain embodiments, the banking system 400 is operated by a first entity, such as a financial institution, while in other embodiments the banking system 400 is operated by an entity other than a financial institution.

It should be understood that the memory device 450 may include one or more databases or other data structures/repositories. The memory device 450 also includes computer-executable program code that instructs the processing device 420 to operate the network communication interface 410 to perform certain communication functions of the banking system 400 described herein. For example, in one embodiment of the banking system 400, the memory device 450 includes, but is not limited to, a network server application 470, a user account data repository 480, which includes user account information 484, an optimization application 321, which includes a mobile device interface 492, and other computer-executable instructions or other data. The computer-executable program code of the network server application 470 or the optimization application 321 may instruct the processing device 420 to perform certain logic, data-processing, and data-storing functions of the banking system 400 described herein, as well as communication functions of the banking system 400.

In some embodiments, the optimization application 321 is the same application as located on the mobile device. In other embodiments, some functionality is present in the financial institution banking system 400 and some functionality is present in the mobile device. As should be understood, the software and hardware providing the optimization functionality can be entirely present on the mobile device, entirely present on the financial institution banking system 400, or divided in some manner between the mobile device and the banking system 400. In further embodiments, the crowdsourcing system also contributes to the optimization functionality by augmenting data and/or processing power of the optimization application(s) 321.

In further embodiments, the mobile device interface 492 facilitates communication between the mobile device and the banking system. For example, the mobile device interface 492 may establish a connection with the mobile device, may encrypt or decrypt communications with the mobile device, or may provide a portal for the user to interact with the optimization application 321 on the banking system 400 through the mobile device.

As used herein, a “communication interface” generally includes a modem, server, transceiver, and/or other device for communicating with other devices on a network, and/or a user interface for communicating with one or more users. Referring again to FIG. 4, the network communication interface 410 is a communication interface having one or more communication devices configured to communicate with one or more other devices on the network 210, such as the mobile device 270, the plurality of business-merchants 280, and the banking system 400. The processing device 420 is configured to use the network communication interface 410 to transmit and/or receive data and/or commands to and/or from the other devices connected to the network 210.

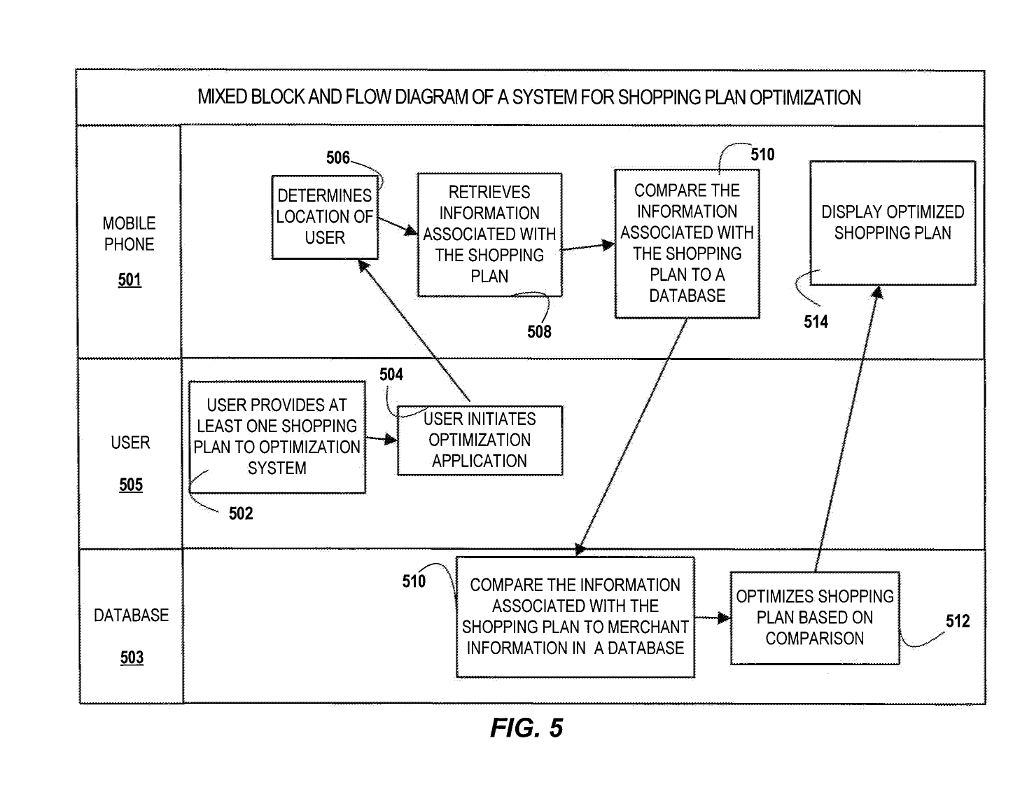

FIG. 5 provide a mixed block and flow diagram of system 500 for showing actions taken by the user, the optimization application, and the mobile device to provide shopping plan optimization for a user, in accordance with an exemplary embodiment of the invention. While the steps are depicted as performed by one of the parties listed in the flow chart, the steps do not need to be performed by that exact party. For example, the user is depicted as initiating the optimization application on the mobile device in block 504; however, the optimization application may do this instead of or in addition to the user. For example, the optimization application may determine the user's presence in or proximate to a business-merchant and automatically initiate the optimization application. It will be understood that the system 500 represent an example embodiment of an apparatus configured to perform the process flow 100 described in connection with FIG. 1. As shown, the system 500 includes a mobile phone 501 (e.g., a mobile device 300, etc.), a database 503 (e.g., database 240), and a user 505 (e.g., user 202). The mobile phone 501 and the database 503 may each include a communication interface, user interface, a processor, a memory, an application, and/or datastore, and those components may be operatively connected to each other.

In block 502, the user provides at least one shopping plan to the optimization system. In an embodiment, the user 505 uploads a list, such as a shopping list or wish list, to the optimization system. The user may provide the shopping plan to the optimization system by manually entering the products and/or services into a software application. In other embodiments, the user 505 emails a list comprising at least one product and/or service to the optimization system. In still further embodiments, the user 505 provides the shopping plan by authorizing a third party, such as a family member, a manufacturer, a financial institution, or a business-merchant to provide a shopping plan to the optimization system. In another embodiment, the user may verbally record the shopping plan to the optimization system. For example, a user's spouse may wish to update the shopping plan for the user by emailing the user a product that should be picked up at the store. When the user 505 reaches the store, the method 500 directs the user 505 to the specific product requested by the user's spouse. If the user 505 authorizes a manufacturer, financial institution, or business-merchant to provide products to the optimization the system, the user may be directed to those products when reaching a business. In a further embodiment, the manufacturer, financial institution, or business-merchant may provide offers to the user 505, such as coupons, discounts, or rewards points in return for directing the user to the product. The user 505 may provide the at least one shopping plan to the optimization system in a variety of ways, and the aforementioned list is not intended to be limiting. For example, the user can provide items to the optimization system by taking a picture of a product, bar code, or advertisement and then being directed to the business-merchant having the associated product or the user may be directed to the associated product within a business-merchant store location.

In some embodiments, the user 505 also provides preferences, such as a merchant-type, merchant name, distance to merchant, maximum price, or a distance associated with the products and/or services associated with the shopping plan. For example, the user 505 may desire to purchase product A at business A. Similarly, the user 505 may wish to purchase product A if it costs less than $X dollars or if product A can be found at a store within X miles of the user. It should be understood that many different limitations can be placed on the shopping plan that the user is optimizing using the system and method. For example, the user 505 may specify that the computer-implemented method should not include the product A in the optimized shopping plan unless product B, C, and D are also available in the business. The user may wish to prepare a recipe but only if all ingredients are available.

In block 504, the user 505 initiates the optimization application on the mobile phone 501. In this embodiment, the user 505 activates an application on the mobile phone that then proceeds to determine the user's location, retrieve information associated with the shopping plan, compare the information associated with the shopping plan to merchant product information for at least one merchant in a database, and optimize the shopping plan based at least partially on the comparison of the information associated with the shopping plan to the merchant product information for at least one merchant in the database. In other embodiments, however, the user 505 initiates the optimization application by authorizing automatic activation of the optimization application based on meeting pre-defined criteria. For example, the user 505 may authorize the optimization application to automatically activate when the user 505 enters a business or is determined to be within a predefined distance of a business. A GPS unit associated with the mobile phone may track the user's location and determine that the user 505 is in proximity to a business having products and/or services provided by the user 505 to the optimization system. In this manner, the user 505 is able to add products and/or services to the optimization system without knowing which businesses have the products and/or services. When the user is entering the business or even merely passing by the business, the user 505 can be alerted to the presence of the products and/or services. In a still further embodiment, the user 505 can authorize the business to activate the optimization application on the mobile phone 501, such as wireless activation upon entering the business. The business may also transmit the most recent planogram, sales information, facility maps, or offers to the user 505 when activating the application on the mobile phone 501.

In block 506, the system may determine the location of the user. In an embodiment, the system determines the location of the user 505 based on triangulation. For example, the system may connect to at least one transmitter of a wireless signal. The computer-implemented method determines the distance from the transmitter and triangulates the location of the user in the business. Any type of wireless signal that can be received in a facility may be used. In an exemplary embodiment, Wi-Fi signals are used to determine the location of the user. For example, the strength of the Wi-Fi signal may be used to determine the distance from the Wi-Fi transmitter. Alternatively, communication time between the Wi-Fi transmitter and the mobile phone 501 may also be calculated. When distance from at least three known locations is provided, algorithms to identify the location of an individual are known.

In some embodiments, the method determines the location of the user 505 based on the user's original location and velocity data associated with the user 505 and/or the mobile phone 501. For example, the system may track the user using GPS while the user is outside the business and capable of receiving satellite signals. When the user enters the business, the system evaluates the current location of the user 505 (e.g., the entry point) and tracks the user's velocity (speed and direction) to continually determine the user's location. Similarly, a user 505 can activate a tracking mechanism by passing through an entrance to the facility. In this manner, the system is provided with the user's current location when the user 505 enters. Then, an accelerometer, magnetometer, or other device can be used to determine the user's velocity. By knowing the user's initial location and tracking the user's velocity based on the mobile phone 501, the system can accurately determine the user's location.

In a further embodiment, the system determines the location of the user based on proximity to pre-set markers. In some embodiments, pre-set markers are established throughout the business. For example, markers may be established at the front and end of every aisle. Markers may be placed regularly throughout the store, such as at set distances along each aisle (e.g., every five feet down an aisle) so that the user 505 is usually or always in proximity to a marker. In some embodiments, the pre-set markers are established in a regular pattern, such as a grid, in the business. In other embodiments, however, the pre-set markers are established in a non-regular pattern. The pre-set markers may be randomly placed throughout the business or placed in key locations, such as at the front of the bakery or at a cash register. Using pre-set markers, the mobile phone 501 is configured to determine the user's location based on the pre-set marker. The mobile phone may identify the nearest pre-set marker or a plurality of pre-set markers to identify the user's location. The pre-set markers may emit a signal, such as from an RFID tag, an NFC-enabled chip, or other signal that can be detected by the mobile phone.

In yet further embodiments, the system determines the location of the user 505 based on video tracking of the user 505 by the business. In some embodiments, the business operates video cameras having tagging or user 505 matching software. The business tracks users via the video camera and, in some embodiments, transmits the location information to the user 505. In an embodiment, individuals opt-in to tracking and, when the individual enters the business, the video camera identifies the individual and tracks the individual through the video camera. The video camera can identify the individual in a variety of ways, such as using facial recognition or detecting a signal produced by the mobile phone. It should be understood that any or all of these methods of determining the location of the individual may be combined with one another. For example, individuals can be initially identified in a video camera based on proximity to pre-set markers.

In block 508, using the mobile phone 501 the optimization application retrieves information associated with the shopping plan. In one embodiment, retrieves the shopping plan comprising a shopping list comprising one or more products and/or services stored on the memory of the user's mobile phone 501. For example, the optimization application accesses the memory device located on the user's mobile phone 501 and generates the shopping plan comprising a list of one or more products. In another embodiment, the information associated with the shopping plan may include the user's preferences regarding optimizing the shopping plan.

In block 510, the system compares the information associated with the shopping list to merchant product information for at least one merchant in a database. In one embodiment, the system compares each of the one or more products and/or services on the shopping list to merchant product information for at least one merchant provided to the database by a plurality of merchants and a financial institution. The merchant production information provided to the database 503 may be updated in real-time or near real-time the financial institution maintaining the database or by the plurality of merchants providing information to the database 503. In this way, the optimization application can determine the most accurate prices, location, and merchants having the products and/or services on the shopping list.

In block 512, the system optimizes the shopping plan based at least partially on the comparison of each of the one or more products and/or services associated with the shopping list to the merchant product information for at least one merchant in the database 503. In accordance with several embodiments, the system can optimize the shopping plan in various ways. In this example embodiment, the system optimizes the shopping plan by determining the one or more products and/or services to augment to a user's shopping plan. In such an embodiment, system analyzes the information associated with the shopping plan including any shopping list and based at least partially on, the user's transaction history data, shopping plan history, and user preferences the system augments complimentary or forgotten products and/or services that should accommodate the one or more products and/or services associated with the user's initial shopping plan. Additionally, the optimization application may optimize the shopping plan prior to the user arriving at the business-merchant, contemporaneous with the user's arrival at the business-merchant, or at any point during the user's visit to the business merchant.

In a further embodiment, the system 500 optimizes the shopping plan by identifying one or more business-merchant locations and/or websites associated with the information associated with the at least one shopping plan. In such embodiments, the system 500 may determine all of the business-merchants having one or more of the items and/or services associated with the shopping plan based on the comparison of each of the one or products and/or services associated with the shopping plan to the database 503, the user's location, and other user preferences.

In block 516, the optimization application provides the optimized shopping plan to the display of the user's mobile phone 501. In accordance with some embodiments, the optimization application may provide the optimized shopping plan to the display of the user in various ways, including, for example, by generating a new shopping plan including any products and/or services augmented to the shopping plan, by displaying in a separate window on the user's mobile phone the recommended additions and/or alternatives, by appending a list or shopping plan to the initial shopping plan of the user 505. In this example embodiment, optimization application generates the optimized shopping plan as new shopping plan to the display of the mobile phone 501 with any new products and/or services augmented to the shopping plan. In other embodiments, the optimization application may provide the optimized shopping plan using an audible device operably connected to the mobile phone.

Although many embodiments of the present invention have just been described above, the present invention may be embodied in many different forms and should not be construed as limited to the embodiments set forth herein, rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

The flowcharts and block diagrams in the figures illustrate the architecture, functionality, and operation of possible implementations of apparatuses, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, functions repeated by the two blocks shown in succession may, in fact, be executed substantially concurrently, or the functions noted in the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer-executable instructions.

It should be understood that terms like “bank,” “financial institution,” and “institution” are used herein in their broadest sense. Institutions, organizations, or even individuals that process financial transactions are widely varied in their organization and structure. Terms like financial institution are intended to encompass all such possibilities, including but not limited to banks, finance companies, stock brokerages, credit unions, savings and loans, mortgage companies, insurance companies, and/or the like. Additionally, disclosed embodiments may suggest or illustrate the use of agencies or contractors external to the financial institution to perform some of the calculations, data delivery services, and/or authentication services. These illustrations are examples only, and an institution or business can implement the entire invention on their own computer systems or even a single work station if appropriate databases are present and can be accessed.

As will be appreciated by one of ordinary skill in the art in view of this disclosure, the present invention may include and/or be embodied as a system (including, for example, one or more apparatuses, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including, resident software, microcode, etc.), an entirely hardware embodiment, or an embodiment combining business method, software, and hardware aspects that may generally be referred to herein as a “system.” Furthermore, embodiments of the present invention may take the form of a computer program product that includes a computer readable storage medium having one or more computer-executable program code portions stored therein. As used herein, a processor, which may include one or more processors, may be “configured to” perform a certain function in a variety of ways, including, for example, by having one or more general purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed:

1. A system for optimizing a shopping plan, said system comprising:
a communication interface;
a database comprising merchant product information for at least one merchant;
a storage device;
a processing device in communication with said communication interface, storage device, and database, wherein said processing device is configured to:
retrieve information associated with the at least one shopping plan;
compare the information associated with the at least one shopping plan to the merchant product information stored in the database; and
optimize the at least one shopping plan based at least partially on the comparison of the information associated with the at least one shopping plan to the merchant product information stored in database.

2. The system of claim 1, wherein the database comprises information associated with a plurality of business-merchants comprising at least merchant store layout information, merchant product information, merchant store location, merchant offer information and wherein said processing device optimizes the at least one shopping plan based at least partially on a comparison of at least one or more of the merchant store layout information, merchant product information, merchant offer information or the merchant store location information with the at least one shopping plan.

3. The system of claim 1, wherein the storage device comprises a profile for a user associated with the at least one shopping plan, wherein the profile comprises at least transaction data associated with the user and shopping plan history associated with the user, and wherein said processing device optimizing the at least one shopping plan based at least partially a comparison the information associated with the at least one shopping plan to the transaction data and shopping plan history associated with the user.

4. The system of claim 1, wherein the processing device is configured to optimize the at least one shopping plan based at least partially on a user's travel schedule.

5. The system of claim 1, wherein the processing device is configured to optimize the at least one shopping plan based at least partially on an opportunity cost to purchase each good and/or service associated with the at least one shopping plan.

6. The system of claim 1, wherein the processing device is configured to optimize the at least one shopping plan based at least partially on a total cost to purchase one or more products and/or services associated with the at least one shopping plan.

7. The system of claim 1, wherein the processing device is configured to optimize the shopping plan based at least partially on perishability of the one or more products and/or services associated with the at least one shopping plan.

8. The system of claim 1, wherein the processing device is configured to use the communication interface to allow the user to visually navigate a merchant store prior to arriving at the business-merchant store.

9. The system of claim 1, wherein the processing device is configured to use the communication interface to allow the user to hear an audible description of the shopping plan for navigation of a business-merchant's store prior to arriving at the store.

10. A method for optimizing a shopping plan, said method comprising:
retrieving information associated with the at least one shopping plan;
comparing the information associated with the at least one shopping plan to merchant product information for at least one merchant; and
optimizing, using a processing device, the at least one shopping plan based at least partially on the comparison of the information associated with the at least one shopping plan to the merchant product information.

11. The method of claim 10, wherein the optimizing the at least one shopping plan comprises determining one or more merchant locations having one or more products and/or services associated with the at least one shopping plan.

12. The method of claim 10, wherein the optimizing the at least one shopping plan comprises determining a path through a merchant store to each of the products and/or services associated with the at least one shopping plan.

13. The method of claim 10, wherein the optimizing the at least one shopping plan comprises determining one or more products and/or services to augment the at least one shopping plan with, wherein said one or more products and/or services are related to a financial institution.

14. The method of claim 10, wherein the optimizing the at least one shopping plan comprises determining one or more alternative products and/or services to substitute in lieu of one or more products and/or services associated with the at least one shopping plan.

15. The method of claim 10, wherein the optimizing the at least one shopping plan comprises determining one or more merchants having all of one or more products and/or services associated with the at least one shopping plan.

16. The method of claim 10, wherein the optimizing the at least one shopping plan comprises determining one or more ads and/or promotions to include with the at least one shopping plan.

17. A computer program product for optimizing a shopping plan, said computer program comprising a non-transitory computer readable medium, wherein the non-transitory computer readable medium comprises one or more computer executable program code portions that, when executed by a computer, cause the computer to:
retrieve information associated with the shopping plan;
compare the information associated with the shopping plan to merchant product information for at least one merchant; and
optimize the at least one shopping plan based at least partially on the comparison of the information associated with the shopping plan to the merchant product information.

18. The computer program product of claim 17, wherein the one or more computer program executable portions, when executed by the computer, cause the computer to:
optimize the at least one shopping plan by determining one or more merchant locations having one or more products and/or services associated with the at least one shopping plan.

19. The computer program product of claim 17, wherein the one or more computer program executable portions, when executed by the computer, cause the computer to:
optimizing the at least one shopping plan comprises determining a path through a merchant store to each of the products and/or services associated with the at least one shopping plan.

20. The computer program product of claim 17, wherein the one or more computer program executable portions, when executed by the computer, cause the computer to:
optimizing the at least one shopping plan comprises determining one or more products and/or services to augment the at least one shopping plan with, wherein said one or more products and/or services are related to a financial institution.

21. The computer program product of claim 17, wherein the one or more computer program executable portions, when executed by the computer, cause the computer to:
optimize the at least one shopping plan via determining one or more alternative products and/or services to substitute in lieu of one or more products and/or services associated with the at least one shopping plan.

22. The computer program product of claim 17, wherein the one or more computer program executable portions, when executed by the computer, cause the computer to:
optimize the at least one shopping plan via determining one or more merchants having all of one or more products and/or services associated with the shopping plan.

23. The computer program product of claim 17, wherein the one or more computer program executable portions, when executed by the computer, cause the computer to:
optimize the at least one shopping plan via determining one or more ads and/or promotions to include with the shopping plan.
